(19) United States
(12) Patent Application Publication
(10) Pub. No.: US 2006/0187511 A1
(43) Pub. Date: Aug. 24, 2006

(54) Device for mounting an optical element, particularly a lens in an objective

(76) Inventor: Johannes Rau, Gerstetten (DE)

Correspondence Address: WELLS ST. JOHN P.S., 601 W. FIRST AVENUE, SUITE 1300, SPOKANE, WA, 99201, US

(21) Appl. No.: 11/333,975

(22) Filed: Jan. 17, 2006

Related U.S. Application Data
(63) Continuation-in-part of application No. PCT/EP03/07746, filed on Jul. 17, 2003.

(51) Int. Cl. G02B 26/08

(52) U.S. Cl. 359/200

(57) ABSTRACT

In the case of a device for mounting a lens or a mirror in an objective, particularly a microlithography projection objective for producing semiconductor elements, the lens or the mirror is connected to a mount directly or via an intermediate element by means of a number of bearing elements. A number of bearing locations are provided on the lens or the mirror or the intermediate element. In each case two bearing locations are respectively connected via connecting points to the two ends of a balance beam of a first series of balance beams. The first series of balance beams is arranged so as to yield at least three articulation points for fastening on the mount.

### BACKGROUND OF THE INVENTION

1. Field of the Invention

The invention relates to a device for mounting a lens in an objective, particularly a microlithography projection objective for producing semiconductor elements, the lens being connected to a mount directly or via an intermediate element by means of a number of bearing elements. The invention also relates in general to a device for mounting an optical element in an objective.

2. Description of the Related Art

In order, particularly in the field of microlithography, to mount lenses for producing semiconductor elements with as little deformation as possible, or to decouple them from deformations of the lens mount that may occur, it has already been proposed in DE 198 59 63 A1 to mount the lenses on as many soft spring legs as possible that are arranged distributed over the circumference of the lens. Because of the manufacturing tolerances and pronounced deformations of the mount, it is nevertheless not always possible to avoid slight deformations of the lens. The suspension of the lens via the many soft spring legs is certainly very well decoupled in terms of deformation, but it is disadvantageous that this type of mounting requires the acceptance of a high degree of softness of the mount for the lens.

DE 196 37 563 A1 has already disclosed a birefringent plane-parallel plate arrangement, a plane-parallel plate that is designed as a so-called quarter-wave plate being mounted in a clamping frame by means of tensioning devices. In order to achieve the required homogeneous tensile stress over a large area in the plane-parallel plate, a row of springs is provided on one side between the plane-parallel plate and the clamping frame, while the plane-parallel plate is connected on the opposite side to the clamping frame via a cascade of balance beams.

### SUMMARY OF THE INVENTION

The present invention is based on the object of providing a possibility of suspending a lens or a mirror, in particular a lens in a microlithography projection objective, that on the one hand is designed with very low deformation or to keep deformations of the lens mount or mirror mount away from the lens or the mirror itself, but which on the other hand has a higher level of stiffness by comparison with known mounts, for example via soft spring legs. An additional aim of the invention consists in very general terms in a mounting that is of low deformation, but stiff. A further aim consists in a microlithography projection objective that is improved with reference to the mounting of lenses or mirrors.

According to the invention, said object is achieved by virtue of the fact that a number of bearing locations act on the lens or the mirror, in each case two bearing locations being respectively connected via connecting points to the two ends of a balance beam of a first series of balance beams, the first series of balance beams being arranged so as to yield at least three articulation points for fastening on the mount.

In accordance with claim 9, this object is achieved in the same way for an optical element, particularly a microlithography projection objective. The optical element can also be a mirror here, for example.

One of the important advantages of the solution according to the invention consists in that owing to the at least three articulation points that are connected via the balance beams to the bearing locations on the lens or on the optical element, a deformation of the mount cannot penetrate as far as the lens or, in very general terms, to the optical element. However, at the same time a substantially higher level of stiffness of the bearing is provided by comparison with the bearing via spring legs.

According to the invention, the force of each of the at least three articulation points on the mount can be divided here into two forces via a balance beam. Each of the six forces thereby produced (given three articulation points) can be divided into two forces in turn via a further balance beam such that twelve bearing locations are subsequently obtained on the lens or the mirror. If a further row of balance beams is placed therebetween, the result is even twenty-four bearing locations that, given ideal soft articulated connecting points of the balance beams, introduce the same forces into the lens in a fashion distributed exactly at the circumference, specifically independently of the axial position (z-direction) of the articulation points.

The at least three articulation points can either be located directly on the mount, or else be connected to the mount via intermediate members.

Possible intermediate members are, for example, actuators by means of which the position of the lens with reference to the mount can be still be influenced, for example the position of the lens along the optical axis (z-axis) and/or a tilting manipulation.

In a very advantageous refinement of the invention, it can be provided that the connection of the at least three articulation points to the mount via further intermediate members is effected in the form of a further cascade of balance beams in such a way that forces acting at the three articulation points are supported in the mount via a multiplicity of articulation locations.

By means of such a refinement, which can be effected, for example, by interfolding two cascades of balance beams, it is possible for the outer mount to be deformed in the z-direction at will without the shape of the inner ring being altered thereby.

Solid joints can be provided as articulated connecting points of the balance beams. In this case, the several interconnected balance beams are in one piece, a very uniform force distribution thereby being ensured.

Of course, in addition to or instead of solid joints it is also possible to provide spherical joints at one or else at all the connecting locations. The same holds true for the articulation points on the mount and/or the coupling points of the balance beams.

Owing to the bearing and/or connecting techniques according to the invention, when forces and deformations occur on the outer ring or the mount an inner ring or the optical element such as, for example, a lens or a mirror, remains flat. If the aim is to introduce forces via regulators, the result is a targeted, uniformly distributed introduction of force.

According to the invention, one option is to connect the optical element to a mount directly via the balance beams with their connecting points and bearing locations. Of course, however, it is also possible within the scope of the invention to undertake a division by means of an intermediate element, placed therebetween, in the form of an inner ring. In this case, the bearing and connecting technique according to the invention is achieved with the balance beams between the inner ring and a first and/or second row of balance beams correspondingly placed therebetween. The bearing of the optical element, for example a lens, or its connection to the inner ring can then be performed in any desired way.

Advantageous further refinements emerge from the remaining subclaims and from the following exemplary embodiment described in principle with the aid of the drawings.

### BRIEF DESCRIPTION OF THE DRAWINGS

FIG. 1 shows a schematic of a projection exposure machine having a projection objective for producing semiconductor elements;

FIG. 2 shows a schematic detail of a circumferential section of the device according to the invention in a first embodiment;

FIG. 3 shows a schematic detail of a circumferential section of the device according to the invention in a second embodiment;

FIG. 4 shows a schematic detail of a circumferential section of the device according to the invention in a third embodiment;

FIG. 5 shows a perspective illustration of a detail of the design according to FIG. 2, in an overall illustration; and

FIG. 6 shows a perspective illustration of the device according to the invention in one embodiment, an intermediate element being provided in the form of an inner ring between a lens and an outer mount.

### DETAILED DESCRIPTION

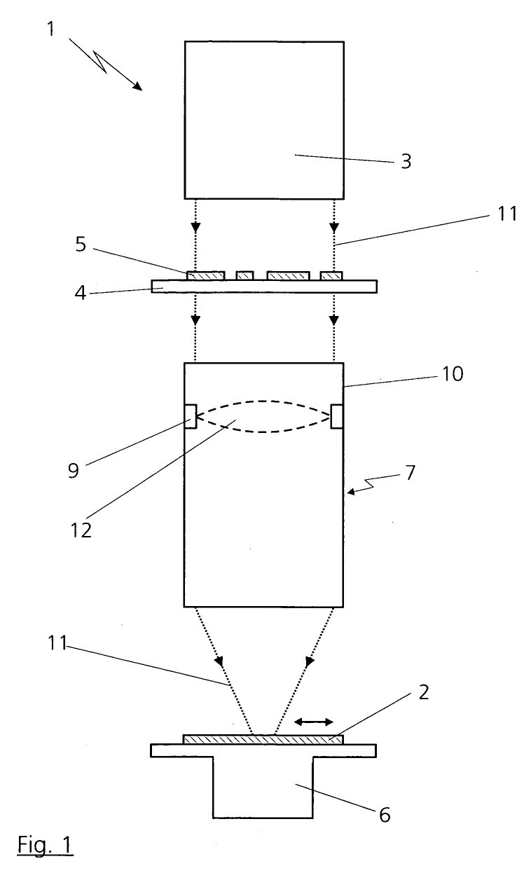

FIG. 1 illustrates a microlithography projection exposure machine 1. This serves for exposing patterns on a substrate that is coated with photosensitive materials and consists in general predominantly of silicon and is denoted as a wafer 2, for the purpose of producing semiconductor components such as, for example, computer chips.

Here, the projection exposure machine 1 essentially comprises an illumination device 3, a device 4 for holding and exactly positioning a mask provided with a grid-like pattern, a so-called reticle 5 by means of which the later patterns on the wafer 2 are determined, a device 6 for holding, moving and exactly positioning this very wafer 2, and an imaging device, specifically a projection objective 7 having a number of optical elements such as, for example, lenses 12, that are mounted in an objective housing 10 of the projection objective 7 via mounts 9.

The fundamental functional principle provides here that the patterns introduced into the reticle 5 are exposed onto the wafer 2 with a reduction in the patterns.

After an exposure has been performed, the wafer 2 is moved further in the direction of the arrow such that a multiplicity of individual fields, each having the pattern prescribed by the reticle 5, are exposed on the same wafer 2. Because of the stepwise feeding movement of the wafer 2 in the projection exposure machine 1, the latter is also frequently denoted as a stepper.

The illumination device 3 provides a projection beam 11, for example light or a similar electromagnetic radiation, required for imaging the reticle 5 on the wafer 2. A laser or the like can be used as source for this radiation. The radiation is shaped via optical elements in the illumination device 3 such that when impinging on the reticle 5 the projection beam 11 has the desired properties with regard to diameter, polarization, shape of the wavefront and the like.

As has already been explained above, an image of the reticle 5 is produced via the projection beam 11 and transmitted onto the wafer 2 in a correspondingly reduced fashion by the projection objective 7. The projection objective 7 has a multiplicity of individual refractive and/or reflective optical elements such as, for example, lenses, mirrors, prisms, end plates and the like. A lens 12 is depicted in FIG. 1 merely by way of example.

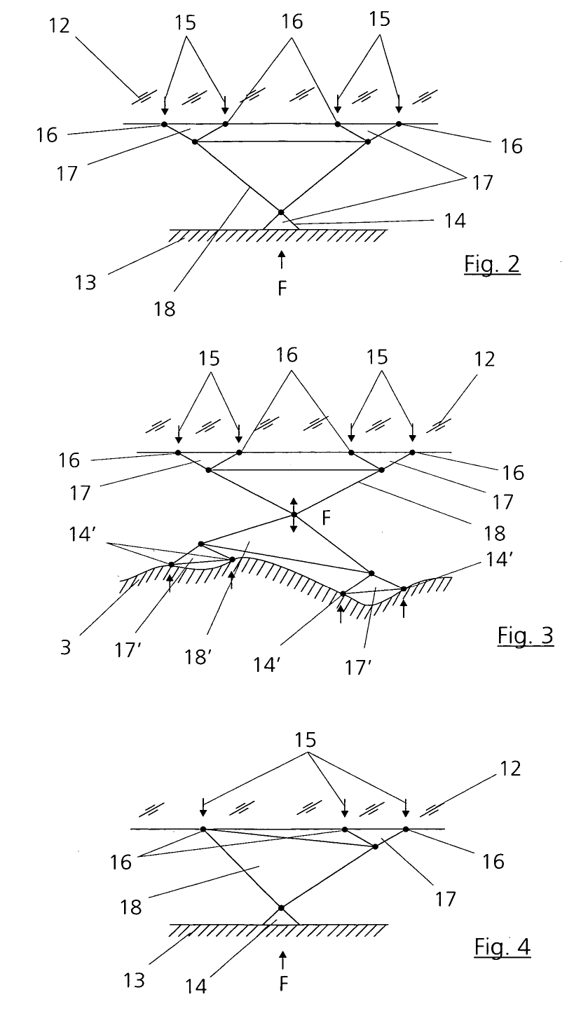

FIGS. 2 to 5 respectively illustrate schematically circumferential sections of possible mountings or possible connecting techniques for a lens 12 in the objective housing 10 of the projection objective 7. Of course, instead of the type of mounting described below for the lens, it is also possible for a mirror to be mounted in the same way.

FIG. 2 shows the mounting of the lens 12 via three articulation points 14 arranged distributed uniformly on the circumference of a mount 13. Only one of the three articulation points 14 is illustrated in FIG. 2. The two other articulation points are situated in each case in a fashion distributed on the circumference at a spacing of 120° from one another. The connection of the mount 13 to the objective housing 10 can be performed in any desired way, for example by means of a screw connection. The three articulation points 14 constitute coupling points for connection to the lens 12 in a fashion capable of pivoting or tilting. As may be seen, the coupling to the lens 12 is performed via a balance beam system. The balance beam system represents one or more carrier elements, which are denoted below as a series of balance beams or cascade of balance beams. Thus, a number of bearing locations 15 are provided on the lens, each bearing location 15 being respectively connected via connecting points 16 to an end of a balance beam 17 of a first series of balance beams.

Each balance beam 17 constitutes a part of a type of balance with at least two two-sided levers, two generally equal-armed lever arms, called levers below, keeping the balance beam 17 in equilibrium or in a tilted state. All the balance beams 17 of the first series, these totaling six in the case of FIG. 2, are connected to a further balance beam 18 via the levers, which support the balance beams, of a second series of balance beams. The connection of the balance beams 17 of the first series of balance beams is performed here respectively in the middle via the levers at their point of intersection, specifically in each case once again with one end of the assigned balance beam 18 of the second series of balance beams. As may be seen, this means that in each case two balance beams 17 of the first series of balance beams are connected via the levers to a balance beam 18 of the second series of balance beams. In the case of the refinement according to FIG. 2, three balance beams 18 of the second series are therefore present which are arranged distributed over the circumference and respectively have the articulation point 14 to the mount 13 in an articulated fashion at their apex or via the levers.

For the mounting of the lens 12, this means that the force of each of the three articulation points 14 is divided into two forces at the ends of the balance beams 18 of the second series of balance beams. This gives rise to six forces that are arranged distributed over the circumference and are divided in turn into two forces via the balance beams 17 of the first series of balance beams, such that a total of twelve mounting points or bearing locations is obtained on the lens 12. If yet a further series of balance beams is placed therebetween, the result is even twenty-four mounting points or bearing locations 16 on the lens 12. As may be seen, with each series of further balance beams, the number of connecting points 16 doubles.

As may be seen, the optical element, for example the lens 12, is therefore held in each case in an isostatically or statically defined fashion. An isostatic or statically defined bearing is to be understood as a bearing with six degrees of freedom, three degrees of rotational freedom and 3 degrees of translational freedom being defined exactly without additional constraining forces.

This means that exactly the same forces are introduced into the lens 12 in each case given ideally soft flexural joints of the balance beams—irrespective of the axial position (optical axis) of the three articulation points 14.

The three articulation points 14 can either be located directly on the mount 13, or can also be connected to the mount 13 via actuators. Actuators (not illustrated) can be used to achieve a manipulation or change in position of the lens 12 in the z-direction (optical axis) and/or tilting manipulations.

As may be seen, the series of balance beams or cascade of balance beams results in a soft but nevertheless stiff mounting. A deformation of the objective housing 10 or the mount 13 cannot penetrate as far as the lens 12 via the three articulation points 14.

FIG. 3 shows a refinement of a connection via a multiplicity of balance beams, in relation to a first cascade of balance beams having first balance beams 17 and second balance beams 18, a second cascade of balance beams with, in turn, first balance beams 17′ of a first series and second balance beams 18′ of a second series being connected counter to one another. As may be seen, in this case it is not only three articulation points 14 that are present on the mount 13, but four articulation points 14 per bearing location, and therefore a total of twelve articulation points 14′ given a distribution of three mounting locations over the circumference. As may be seen, in this case the introduction of force or the passing-on point “F” is situated here between the two cascades of balance beams. Only F/4 is present in each case at the mount 13 and also at the lens 12.

The advantage of this refinement consists in that in this case the mount 13 can be deformed in the z-direction (optical axis) at will without thereby causing a change in the shape or form of the lens 12 (the deformation of the mount 13 is illustrated exaggeratedly in FIG. 3).

FIG. 4 shows a refinement in a third embodiment, a division of the force “F” on three bearing locations 15 with F/3 in each case being provided. In this case, as well, there is a first series of balance beams 17 and a second series of balance beams 18. However, there is a difference that the balance beam 17 acts on one end of the balance beam 18, while the other end of the balance beam 18 is provided as bearing location 15 with a connecting point 16 on the lens 12.

Here, as well, three such refinements are arranged between the mount 13 and the lens 12 in a fashion distributed uniformly over the circumference.

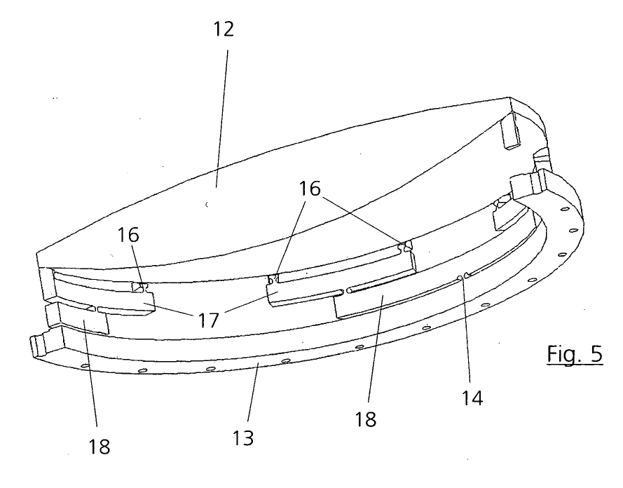

FIG. 5 shows a design embodiment having two cascades of balance beams corresponding to the schematic according to FIG. 2.

The connecting points 16 on the ends of the balance beams with the lens 12 or the other balance beam acting thereon, and also the articulation points on the mount are generally required to be of articulated design. The articulation can be provided either by solid joints or else by spherical joints. In the case of the design over solid joints, this means that the balance beams and, if appropriate, also the mount are of unipartite design.

As may be seen, the series of balance beams can be designed such that the individual balance beams are symmetrical, as is to be seen from FIGS. 2 and 3, or else asymmetric, as is to be seen from FIG. 4. Unipartiteness with solid joints can be effected, for example, by erosion cuts that provide an appropriate weakening of the material and/or articulation at the connecting points and connecting locations.

However, other connecting techniques such as, for example, clamping, soldering, bonding or welding are also possible, of course, within the scope of the invention.

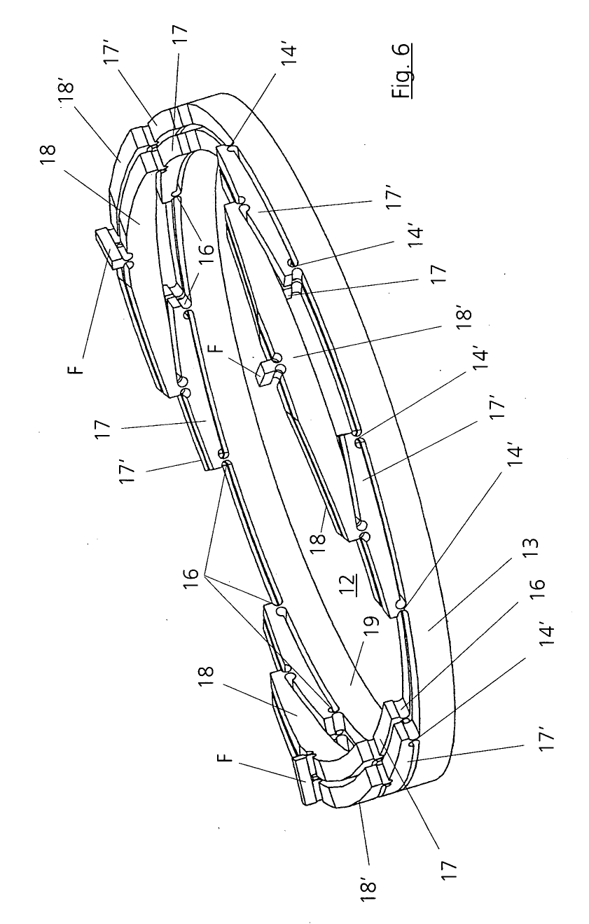

FIG. 6 shows a perspective illustration of a refinement of the invention corresponding to the schematic in accordance with FIG. 3. However, one difference consists in that there is provided between the lens 12 and the mount 13 an intermediate element in the form of an inner mount 19 that is connected via the series of balance beams illustrated schematically in FIG. 3 to the mount 13, which in this case constitutes an outer mount.

In this arrangement, the lens 12 itself is connected to the inner mount 19 in a way not illustrated in more detail.

It is clear from the perspective illustration that the two cascades of balance beams having the balance beams 17, 18 and 17′, 18′ are folded into one another according to the illustration of FIG. 3, the balance beams 17 being connected to the inner mount 19 via the connecting points, and the balance beams 17′ being connected to the outer mount 13. This results in a substantial space saving. The interfolding is performed via three connecting locations at which the force “F” acts.

What is claimed is:

1. A device for mounting a lens or a mirror in an objective, particularly a microlithography projection objective for producing semiconductor elements, the lens or the mirror being connected to a mount directly or via an intermediate element by means of a number of bearing elements, a number of bearing locations being provided on the lens or the mirror or the intermediate element, in each case two bearing locations being respectively connected via connecting points to the two ends of a balance beam of a first series of balance beams, the first series of balance beams being arranged so as to yield at least three articulation points for fastening on the mount.

2. The device as claimed in claim 1, each of the balance beams of the first series, at whose ends the connecting points for the bearing locations of the lens or the mirror or the intermediate element are arranged, being connected to at least one further balance beam of a second series of balance beams, the arrangement being repeated as a cascade of balance beams until there remain at least three articulation points that are connected to the cascade of balance beams via articulated connecting points and are connected to the mount directly or via further intermediate members.

3. The device as claimed in claim 2, the connection of the at least three articulation points to the mount via further intermediate members being effected in the form of a further cascade of balance beams in such a way that forces acting at the three articulation points are supported in the mount via a multiplicity of bearing locations.

4. The device as claimed in claim 1, the connecting points at the ends of the balance beams being of articulated design.

5. The device as claimed in claim 4, the articulated connecting points on the balance beams being formed by solid joints.

6. The device as claimed in claim 1, the articulation points on the mount being formed by solid joints.

7. The device as claimed in claim 2, the balance beams being constructed symmetrically with the series of balance beams.

8. The device as claimed in claim 2, at least twelve bearing locations arranged distributed over the circumference of the lens acting on the lens, two bearing locations respectively being connected to one end of a balance beam of the first series via one articulated connecting point, two balance beams of the first series respectively being connected at coupling points to the ends of a further balance beam of the second series, and at least three balance beams of the second series being connected to the mount via coupling points as articulation points.

9. The device as claimed in claim 2, three bearing units each having three bearing locations being respectively provided on the lens or the mirror in a fashion distributed over the circumference, each bearing location being connected via an articulated connecting point to one end of a balance beam of a first series of balance beams, a balance beam of the first series respectively being articulated with one end at the coupling point of another, adjacently situated balance beam of the first series via an articulated connecting point, and the articulation point being connected in an articulated fashion to the balance beams of the first series via a balance beam of a second series with the aid of the mount or an intermediate member connected to the mount, this being done in such a way that one end of the balance beam of the second series acts on a bearing location of the lens, while the other end thereof is articulated at the coupling point of the other balance beam of the first series.

10. A device for mounting an optical element in a microlithography projection objective for producing semiconductor elements, the optical element being connected to a mount directly or via an intermediate element by means of a number of bearing elements, a number of bearing locations acting on the optical element, in each case two bearing locations being connected via an articulated connecting point to the two ends of a balance beam of a first series of balance beams, the first series of balance beams being arranged so as to yield at least three articulation points for fastening on the mount.

11. The device for mounting an optical element as claimed in claim 10, each of the balance beams of the first series, at whose ends the connecting points for the bearing locations of the optical element are arranged, being connected to at least one further balance beam of a second series of balance beams, the arrangement being repeated as a cascade of balance beams until there remain at least three articulation points that are connected to the cascade of balance beams via articulated connecting points and are connected to the mount directly or via further intermediate members.

12. The device for mounting an optical element as claimed in claim 11, the connection of the at least three articulation points to the mount via further intermediate members being effected in the form of a further cascade of balance beams in such a way that forces acting at the three articulation points are supported in the mount via a multiplicity of bearing locations.

13. The device for mounting an optical element as claimed in claim 11, at least twelve bearing locations arranged distributed over the circumference of the optical element acting on the optical element, two bearing locations respectively being connected to one end of a balance beam of the first series via one articulated connecting point, two balance beams of the first series respectively being connected at coupling points to the ends of a further balance beam of the second series, and at least three balance beams of the second series being connected to the mount via coupling points as articulation points.

14. The device for mounting an optical element as claimed in claim 11, three bearing units each having three bearing locations being respectively provided on the optical element in a fashion distributed over the circumference, each bearing location being connected via an articulated connecting point to one end of a balance beam of a first series of balance beams, a balance beam of the first series respectively being articulated with one end at the coupling point of another, adjacently situated balance beam of the first series via an articulated connecting point, and the articulation point being connected in an articulated fashion to the balance beams of the first series via a balance beam of a second series with the aid of the mount or an intermediate member connected to the mount, this being done in such a way that one end of the balance beam of the second series acts on a bearing location of the optical element, while the other end thereof is articulated at the coupling point of the other balance beam of the first series.

15. The device for mounting an optical element as claimed in claim 1, the intermediate element being designed as an inner mount on which the number of bearing locations are provided, the at least three articulation points being provided on an outer mount.

16. A microlithography projection objective for producing semiconductor elements, comprising at least one lens or a mirror, the at least one lens or the mirror being connected to a mount directly or via an intermediate element by means of a number of bearing elements, a number of bearing locations being provided on the lens or the mirror or the intermediate element, in each case two bearing locations being respectively connected via connecting points to the two ends of a balance beam of a first series of balance beams, the first series of balance beams being arranged so as to yield at least three articulation points for fastening on the mount.

17. The projection objective as claimed in claim 16, each of the balance beams of the first series, at whose ends the connecting points for the bearing locations of the lens or the mirror or the intermediate element are arranged, being connected to at least one further balance beam of a second series of balance beams, the arrangement being repeated as a cascade of balance beams until there remain at least three articulation points that are connected to the cascade of balance beams via articulated connecting points and are connected to the mount directly or via further intermediate members.

18. The projection objective as claimed in claim 17, the connection of the at least three articulation points to the mount via further intermediate members being effected in the form of a further cascade of balance beams in such a way that forces acting at the three articulation points are supported in the mount via a multiplicity of bearing locations.

19. The projection objective as claimed in claim 17, at least twelve bearing locations arranged distributed over the circumference of the lens acting on the lens, two bearing locations respectively being connected to one end of a balance beam of the first series via one articulated connecting point, two balance beams of the first series respectively being connected at coupling points to the ends of a further balance beam of the second series, and at least three balance beams of the second series being connected to the mount via coupling points as articulation points.

20. The projection objective as claimed in claim 17, three bearing units each having three bearing locations being respectively provided on the lens or the mirror in a fashion distributed over the circumference, each bearing location being connected via an articulated connecting point to one end of a balance beam of a first series of balance beams, a balance beam of the first series respectively being articulated with one end at the coupling point of another, adjacently situated balance beam of the first series via an articulated connecting point, and the articulation point being connected in an articulated fashion to the balance beams of the first series via a balance beam of a second series with the aid of the mount or an intermediate member connected to the mount, this being done in such a way that one end of the balance beam of the second series acts on a bearing location of the lens, while the other end thereof is articulated at the coupling point of the other balance beam of the first series.

21. An isostatically held optical element in a microlithography projection exposure machine, having a mount and having at least two carrier elements for connecting the mount to the optical element, each carrier element having at least one first series of balance beams with at least two two-sided levers of which the first lever is held rotatively on a lever arm of the second lever and is connected with its two lever arms to the optical element or with at least one of its lever arms to a further two-sided lever for the purpose of connection to the optical element, and the optical element or a further two-sided lever is connected to the other lever arm of the second lever for the purpose of connection to the optical element, the second lever being held rotatively on the mount or a second series of balance beams for connection to the mount, the second series of balance beams having at least two two-sided levers in a way corresponding to the first one, of which the first lever of the second series of balance beams is held rotatively on a lever arm of the second lever of the second series of balance beams, and is connected with its two lever arms to the mount, or with at least one lever arm to a further two-sided lever for connection to the mount, and the mount or a further two-sided lever being connected to the other lever arm of the second lever of the second series of balance beams for connection to the mount.

22. An isostatically held optical element in a microlithography projection exposure machine, having a mount and having at least two carrier elements for connecting the mount to the optical element, each carrier element having at least one first series of balance beams with at least two two-sided levers of which the first lever is held rotatively on a lever arm of the second lever and is connected with its two lever arms to the optical element, or with in each case one of its lever arms to a further two-sided lever for the purpose of connection to the optical element, and at least one further two-sided lever is connected to the other lever arm of the second lever for connection to the optical element, the second lever being held rotatively on the mount.

23. An optical element in a microlithography projection exposure machine, having a mount and having at least one carrier element for connecting the mount to the optical element, the carrier element having at least one first series of balance beams with at least two two-sided levers of which the first lever is held rotatively on a lever arm of the second lever and is connected with its two lever arms to the optical element or with in each case one of its lever arms to a further two-sided lever for the purpose of connection to the optical element, and at least one further two-sided lever being connected to the other lever arm of the second lever for the purpose of connection to the optical element, the second lever being held rotatively on a second series of balance beams for connection to the mount, the second series of balance beams having at least two two-sided levers in a way corresponding to the first one, of which the first lever of the second series of balance beams is held rotatively on a lever arm of the second lever of the second series of balance beams, and is connected with its two lever arms to the mount, or with at least one lever arm to a further two-sided lever for connection to the mount, and at least one further two-sided lever is connected to the other lever arm of the second lever of the second series of balance beams for connection to the mount.

24. An optical element in a microlithography projection exposure machine, having a mount and having at least one carrier element for connecting the mount to the optical element, the carrier element having at least one first series of balance beams with at least two two-sided levers of which the first lever is held rotatively on a lever arm of the second lever and is connected with its two lever arms to the optical element or with at least one of its lever arms to a further two-sided lever for the purpose of connection to the optical element, and the optical element is connected to the other lever arm of the second lever, the second lever being held rotatively on the mount.

25. Stress-poor, preferably isostatic mounting of an optical element in a microlithography projection exposure machine, having a mount and having at least two carrier elements for connecting the mount to the optical element, each carrier element having at least two two-sided levers with lever arms, at least one lever arm of a two-sided lever of the carrier element being connected with at least one of its lever arms to the fulcrum of a further lever of the carrier element, at least two lever arms of the levers of the carrier element being connected to the optical element, and a lever of the carrier element having an articulation point on the mount.

26. An isostatically held optical element that is connected to a mount, in particular an optical element in a microlithography projection exposure machine, more than three bearing locations being provided on the optical element for mounting in the mount.
